(19) United States
(12) Patent Application Publication
(10) Pub. No.: US 2017/0141928 A1
(43) Pub. Date: May 18, 2017

(54) MULTIPLE ONE-TIME-CERTIFICATE-GENERATION

(71) Applicant: International Business Machines Corporation, Armonk, NY (US)

(72) Inventors: Elli Androulaki, Zurich (CH); Angelo DeCaro, Zurich (CH); Thorsten Kramp, Kilchberg (CH); Alessandro Somiotti, Zurich (CH)

(21) Appl. No.: 15/295,027

(22) Filed: Oct. 17, 2016

Related U.S. Application Data
(60) Provisional application No. 62/256,146, filed on Nov. 17, 2015.

(51) Int. Cl. H04L 9/32; H04L 9/30; H04L 9/08; H04L 9/14

(52) U.S. Cl. CPC H04L 9/3268; H04L 9/14; H04L 9/30; H04L 9/0866

(57) ABSTRACT

Embodiments of the present invention may include issuing certificates in a network of computer systems by receiving a request for a certificate from a user, the request including a public key having a private key having at least one other corresponding public key, determining a user of the public key is authorized using the private key, incrementing a count of certificates for the user, generating a message including the incremented count of certificates for the user, encrypting the generated message, and issuing and transmitting to the user a certificate have the encrypted message as a serial number.

### CROSS-REFERENCE TO RELATED APPLICATIONS

This application claims the benefit of U.S. Provisional Application No. 62/256,146, filed Nov. 17, 2015, which is hereby incorporated by reference in its entirety.

### BACKGROUND

The present disclosure relates to encryption in general, and to generation and use of private and public keys.

Public Key Infrastructure (PKI) is a well-known infrastructure used to create roots of trust for certificates and ways of verifying, auditing and revoking certificates. However, problems arise with conventional PKI when trying to generate or obtain PKI certificates for one-time use. A need arises for techniques that solve these problems and provide improved efficiency and privacy.

### SUMMARY

Embodiments of the present invention may provide techniques for generating or obtaining PKI certificates that may provide improved efficiency and privacy.

For example, in one exemplary embodiment a method may comprise obtaining many X.509 certificates for one-time use, ensuring that any two one-time use certificates are not mutually linkable by anyone in the system other than a trusted auditor, ensuring that a trusted auditor can perform the linking operation which is denied to other system entities, ensuring that the generation of the certificate is not taxing for the client, ensure that certificates can be revoked efficiently, ensuring that the data structures of the certificate authority do not grow linearly in the number of issued certificates, ensuring that revocation of these certificates can be done efficiently.

Accordingly, embodiments of the present invention may employ a certificate authority configured to issue certificates on public keys of other entities of one or more systems. These entities may wish to use certificates only once, so that their actions (involving these certificates) are not traced. As a consequence, they may need one certificate per action (involving certificates). As disclosed herein and below, embodiments of the present invention may employ a special type of asymmetric cryptosystem where the keypair identifying a user is created only once and multiple public keys may be generated to be incorporated in anonymous certificates, such that these public keys cannot be linked together and share the same private key corresponding to that of the keypair used. Furthermore, all such public keys may be certified in a way that also their certificates are mutually unlinkable. Notwithstanding the above an auditor can link together all certificates belonging to a user.

Accordingly, embodiments of the present invention may include methods and systems whereby one or more users, a certificate authority (CA), and a trusted auditor (TA) may interact to perform and process multiple steps whereby in an initial setup in which a given user, Uᵢ, generates a keypair and keeps the private key secret. Thereafter, a request for a one-time use certificate is made in which a given user Uᵢ wants to get a new certificate for a fresh public key generated from the keypair above and whose private key corresponds to that of the keypair used. The user then goes to the CA and sends a certificate request. The CA at first identifies the user. If the user is not a member of the system, the CA rejects the request. If the request is accepted, the user can send the new public key to be certified. The user is asked to prove knowledge of the associated private key. If this step fails, the CA rejects the request. If the request is accepted, the CA looks up the user in an internal table called the issued table. (Each user has an entry in this table: for each user, the CA keeps track of an integer (that starts, for example, at 0) counting the number of issued certificates.) The CA retrieves the associated integer (termed “j”), increments it, puts the incremented value back in the table, and creates a message m<−“Uᵢ₋ⱼ”. Then the CA encrypts m to be e<−Enc(K, m). K is a CA-wide key to encrypt serial numbers. Then the CA performs the standard certificate issue algorithm, with the only exception that the serial number of the issued certificate is e.

Thereafter, the one-time certificates can be used as any other X.509 certificate.

In case it is needed for legal or other reasons, the TA can link the activities of a given user Uᵢ. This can be done by inspecting all instances where a certificate issued by the CA was used and collecting the serial numbers. Serial numbers are encrypted so that they are untraceable to anyone who is not in possession of the key that was used to encrypt them (K). However, the TA can be given this key and with it, the TA can decrypt all serial numbers.

Further, embodiments of the present technique may include a possibility to make the above-mentioned linking more selective by having the CA use a separate key per user. Instead of using the same key K to encrypt all serial numbers, the CA may use one key per user (termed “KUᵢ” for user Uᵢ). The TA can then be given only KUᵢ if the activities of user Uᵢ are to be linked. This links activities of user Uᵢ, keeping activities of all other users unlinkable. This requires adding a common, public prefix P to the message m to make it “P-Uᵢ₋ⱼ”. This way, the TA can try to decrypt all serial numbers and see if the decrypted message starts with P. If it does not, then the TA can be sure that this serial number belonged to another user. Another way is to use authenticated encryption.

Further, embodiments of the present technique may make it possible to avoid the situation in which the CA has to store as many keys KUᵢ as there are users Uᵢ. This may be achieved by having the CA store only the key K, and by obtaining KUᵢ using a key derivation mechanism (for example, KUᵢ<−HMAC(K, Uᵢ)). This achieves selective traceability at the cost of storing a single key only.

Further, embodiments of the present invention may include revoking certificates, whereby the CA can revoke all certificates issued to a user by consulting the issued table for user Uᵢ. Assuming that the number of issued certificates is j, the CA may compute a set of serial numbers to be revoked as S={e<−Enc(K, “Uᵢ₋ₙ”) for all n in [0, j]}. S may then be added to the certificate revocation list of the CA.

Further, embodiments of the present invention may include a method of issuing certificates in a network of computer systems comprising receiving a request for a certificate from a user, the request including a public key having a private key having at least one other corresponding public key, determining user knowledge of the private key corresponding to the public key to be certified, incrementing a count of certificates for the user, generating a message including the incremented count of certificates for the user, encrypting the generated message and issuing and transmitting to the user a certificate have the encrypted message as a serial number.

A key used to encrypt the generated message may be a common key that is the same for all users. A key used to encrypt the generated message may be different for each user. Each generated, encrypted message includes a common, public prefix and the certificates for a user can be linked by decrypting messages using the user's key and linking those for which the common, public prefix is found. The different key for each user may be generated based on a common key. The method may further comprise generating a set of serial numbers for a user, each serial number based on an integer from zero up to a count of certificates for the user and revoking certificates having the generated serial numbers.

Further, embodiments of the present invention may include a system for issuing certificates in a network of computer systems, the system comprising a processor, memory accessible by the processor, and computer program instructions stored in the memory and executable by the processor to perform: receiving a request for a certificate from a user, the request including a public key having a private key having at least one other corresponding public key, determining a user of the public key is authorized using the private key, incrementing a count of certificates for the user, generating a message including the incremented count of certificates for the user, encrypting the generated message, and issuing and transmitting to the user a certificate have the encrypted message as a serial number.

Further, embodiments of the present invention may include a computer program product for issuing certificates in a network of computer systems, the computer program product comprising a computer readable medium and computer program instructions stored on the computer readable medium and executable by a processor to perform: receiving a request for a certificate from a user, the request including a public key having a private key having at least one other corresponding public key, determining a user of the public key is authorized using the private key, incrementing a count of certificates for the user, generating a message including the incremented count of certificates for the user, encrypting the generated message, and issuing and transmitting to the user a certificate have the encrypted message as a serial number.

### BRIEF DESCRIPTION OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows flowchart diagrams of methods, in accordance with some exemplary embodiments of the disclosed subject matter.

FIG. 2 shows block diagrams of systems in which the disclosed subject matter may be used, in accordance with some exemplary embodiments of the subject matter.

FIG. 3 shows a computerized environment in which the disclosed subject matter may be used, in accordance with some exemplary embodiments of the subject matter.

### DETAILED DESCRIPTION

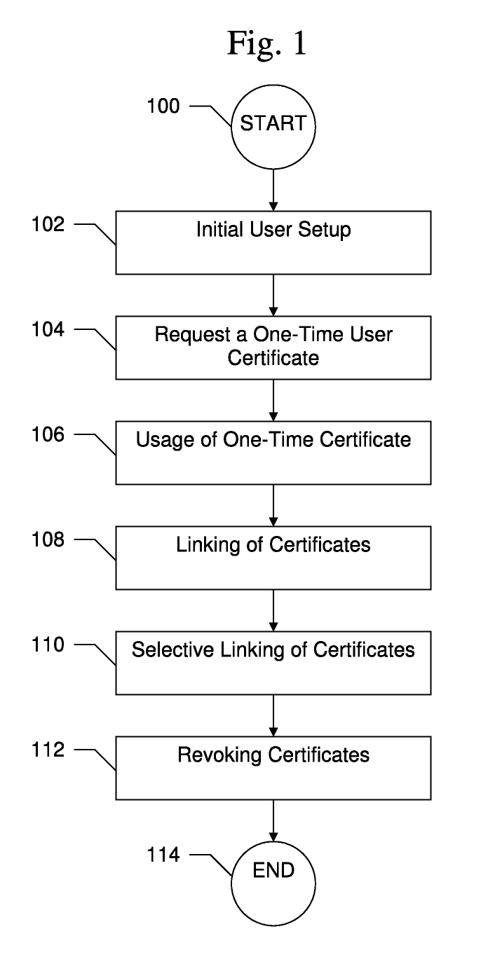

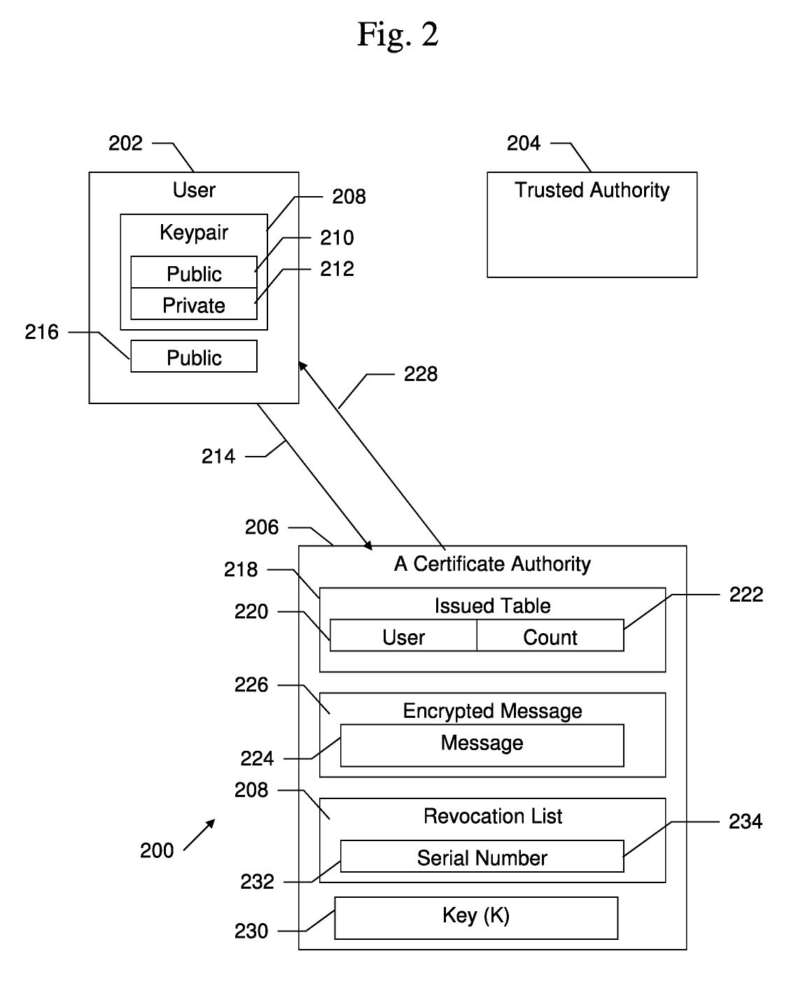

Turning now to the figures, FIG. 1 is a flowchart diagramming methods, in accordance with some exemplary embodiments of the disclosed subject matter. Those skilled in the art will appreciate the method illustrated by the flowchart of FIG. 1 is merely exemplary and that alternate variations may be employed, all in accordance with the present technique. FIG. 1 is best viewed in conjunction with FIG. 2, which shows a computerized environment or system 200 in which the disclosed subject matter may be used, in accordance with some exemplary embodiments of the subject matter.

The system 200 may include a user 202, a trusted authority 204 and a certificate authority 206. The user 202, TA 204 and CA 206, as illustrated, each may comprise one or more processing elements, such as processors, servers, and so forth. Furthermore, the systems 200 and each of the aforementioned elements may be adapted to perform the method as shown in FIG. 1 and all its steps.

Returning to FIG. 1, the method may start at step 100 of the flowchart of FIG. 1. At step 102, an initial user setup may be performed in which a given user Uᵢ 202 generates a keypair 208 including a public key 210 and a private key 212, and keeps the private key 212 secret. Thereafter, at step 104, a request 214 for a one-time use certificate may be made. Hence, at step 104 a given user Uᵢ 202 may desire to get a new certificate. At first, the user may generate a new public key 216 from the keypair 208 that was generated in step 102. Note that the private key 212 may be the same as the one generated in step 102. The user may then go to the CA 206 and send a certificate request 214. The CA 206 may at first identify the user. If the user is not a member of the system, the CA 206 may reject the request. If the request is accepted, the user may send the new public key 216 to be certified. The user may be asked to prove knowledge of the associated private key 212. How this is done depends on the nature of the keypair. If the keypair is a keypair of the signing scheme, then the user may sign the certification request using the private key corresponding to the public key to be certified. The CA then checks that the signature attached to request verifies against the public key in the request. If the keypair is one of an encryption scheme, then upon receiving a certification request, the CA encrypts a random message with the public key in the request and asks the user to decrypt the generated ciphertext. If the user sends back the same random message generated by the CA then the CA accepts the certification request.

If this step fails, the CA 206 may reject the request. If the request is accepted, the CA 206 may look up the user in an internal table called the issued table 218. Each user has an entry in this table: for each user 220, the CA 206 keeps track of a count 222 (for example, an integer that starts at 0) of the number of issued certificates. The CA 206 may retrieve the associated count 222 (termed “j”), increment j, put the incremented value back in the table 218, and create a message m<−“Uᵢ₋ⱼ” 224. Then the CA 206 may encrypt message m 224 to be e<−Enc(K, m) 226. K may be a CA-wide key to encrypt serial numbers. Then the CA 206 may perform the standard certificate issue algorithm, with the only exception that the serial number of the issued certificate 228 may be e.

The method may proceed to step 106, in which the one-time certificates may be utilized. Accordingly, the one-time certificates may be used as can any other X.509 certificate. Thereafter, the method may advance to step 108, in which certificates are linked. For example, linking may be employed for legal or other reasons, and the TA may link the activities of a given user Uᵢ. This may be done by inspecting all instances where a certificate issued by the CA was used and collecting the serial numbers. Serial numbers may be encrypted so they are untraceable to anyone who is not in possession of the key that was used to encrypt them (K). However, the TA 204 may be given this key and with it, the TA 204 may decrypt all serial numbers.

Thereafter, the method as shown in FIG. 1 proceeds to step 110, whereby selective linking of certificates may be performed. Hence, in accordance with embodiments of the present technique, it may be possible to make this linking more selective by having the CA 206 use a separate key per user. Instead of using the same key K to encrypt all serial numbers, the CA 206 uses one key per user (termed “KUᵢ” for user Uᵢ). The TA may then be given only KUᵢ if the activities of user Uᵢ are to be linked. This may link activities of user Uᵢ while keeping activities of all other users unlinkable. This may require adding a common, public prefix P to the message m to make it “P-Uᵢ₋ⱼ”. This way, the TA may try to decrypt all serial numbers and see if the decrypted message starts with P. If it does not, then the TA may be assured that this serial number belonged to another user. Alternatively, other techniques, such as authenticated encryption may be used.

Further, in some embodiments it may be possible to avoid the CA 206 having to store as many keys KUᵢ as there are users Uᵢ. This may be achieved by having the CA 206 store only key K 230, and by obtaining KUᵢ using a key derivation mechanism (for example, KUᵢ<−HMAC(K, Uᵢ)) This achieves selective traceability at the cost of storing a single key only.

From step 110, the method proceeds to step 112, whereby revoking of certificates may be performed. Accordingly, in some embodiments, the CA 206 may revoke all certificates issued to a user by consulting the issued table 220 for user Uᵢ. Assuming that the number of issued certificates is j, CA 206 may compute a set of serial numbers 232 to be revoked as S={e<−Enc(K, “Ui-n”) for all n in [0, j]}. S 232 may be added to the certificate revocation list 234 of CA 206.

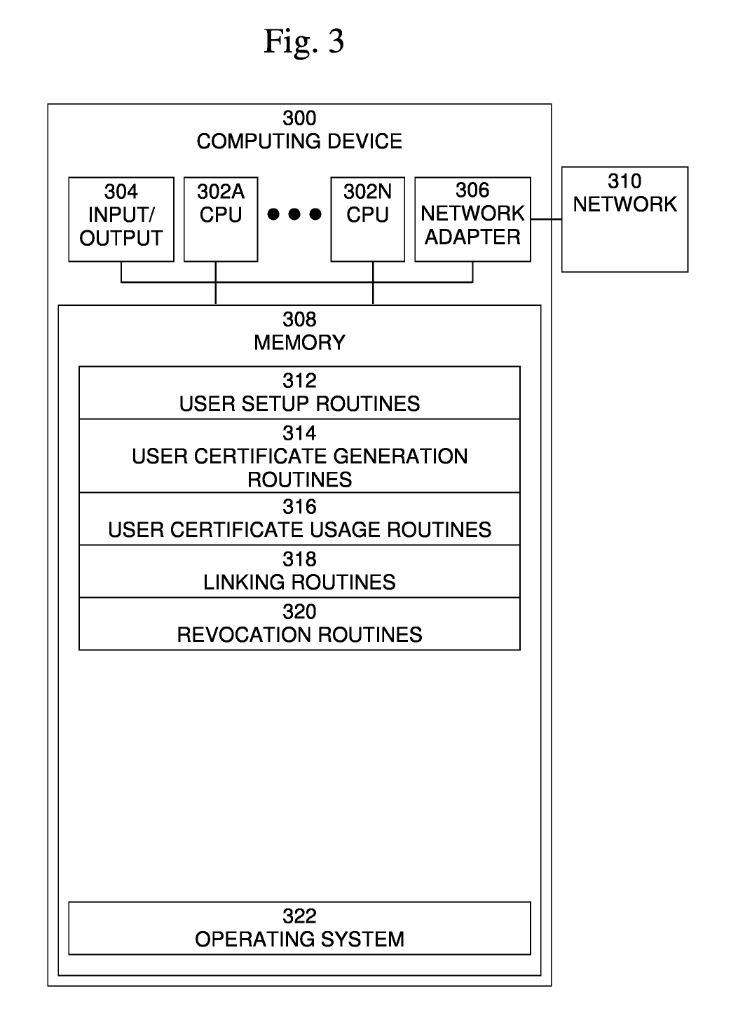

An exemplary block diagram of a computer system 300, in which processes involved in the embodiments described herein may be implemented, is shown in FIG. 3. Computer system 300 is typically a programmed general-purpose computer system, such as an embedded processor, system on a chip, personal computer, workstation, server system, and minicomputer or mainframe computer. Computer system 300 may include one or more processors (CPUs) 302A-302N, input/output circuitry 304, network adapter 306, and memory 308. CPUs 302A-302N may execute program instructions in order to carry out the functions of the present invention. Typically, CPUs 302A-302N may be one or more microprocessors, such as an INTEL PENTIUM® processor. FIG. 3 illustrates an embodiment in which computer system 300 is implemented as a single multi-processor computer system, in which multiple processors 302A-302N share system resources, such as memory 308, input/output circuitry 304, and network adapter 306. However, the present invention also contemplates embodiments in which computer system 300 is implemented as a plurality of networked computer systems, which may be single-processor computer systems, multi-processor computer systems, or a mix thereof.

Input/output circuitry 304 provides the capability to input data to, or output data from, computer system 300. For example, input/output circuitry may include input devices, such as keyboards, mice, touchpads, trackballs, scanners, analog to digital converters, etc., output devices, such as video adapters, monitors, printers, etc., and input/output devices, such as, modems, etc. Network adapter 306 interfaces device 300 with a network 310. Network 310 may be any public or proprietary LAN or WAN, including, but not limited to the Internet.

Memory 308 stores program instructions that are executed by, and data that are used and processed by, CPU 302 to perform the functions of computer system 300. Memory 308 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 308 may vary depending upon the function that computer system 300 is programmed to perform. In the example shown in FIG. 3, exemplary memory contents are shown representing routines and data for embodiments of the processes described above. However, one of skill in the art would recognize that these routines, along with the memory contents related to those routines, may not be included on one system or device, but rather may be distributed among a plurality of systems or devices, based on well-known engineering considerations. The present invention contemplates any and all such arrangements.

In the example shown in FIG. 3, memory 308 may include user setup routines 312, user certificate generation routines 314, user certificate usage routines 316, linking routines 318, revocation routines 320, and operating system 326. For example, user setup routines 312 may include routines to generate a keypair for a user, as shown at 102 in FIG. 1. User certificate generation routines 314 may include routines to generate one or more new certificates, as shown at 104 in FIG. 1. User certificate usage routines 316 may include routines that may be used by a user to utilize one or more certificates, and/or may include routines that allow a user to utilize the certificates, as shown at 106 in FIG. 1. Linking routines 318 may include routines to provide linking of certificates, as shown at 108 in FIG. 1, and to provide selective linking of certificates, as shown at 110 in FIG. 1. Revocation routines 320 may include routines to revoke certificates of a user, as shown at 112 in FIG. 1. Operating system 326 provides overall system functionality.

As shown in FIG. 3, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of issuing certificates in a network of computer systems comprising:
receiving a request for a certificate from a user, the request including a public key having a private key having at least one other corresponding public key;
determining user knowledge of the private key corresponding to the public key to be certified;
incrementing a count of certificates for the user;
generating a message including the incremented count of certificates for the user;
encrypting the generated message; and
issuing and transmitting to the user a certificate having the encrypted message as a serial number.

2. The method of claim 1, wherein a key used to encrypt the generated message is a common key that is the same for all users.

3. The method of claim 1, wherein a key used to encrypt the generated message is different for each user.

4. The method of claim 3, wherein each generated, encrypted message includes a common, public prefix and the certificates for a user can be linked by decrypting messages using the user's key and linking those for which the common, public prefix is found.

5. The method of claim 3, wherein the different key for each user is generated based on a common key.

6. The method of claim 1, further comprising:
generating a set of serial numbers for a user, each serial number based on an integer from zero up to a count of certificates for the user; and
revoking certificates having the generated serial numbers.

7. A system for issuing certificates in a network of computer systems, the system comprising a processor, memory accessible by the processor, and computer program instructions stored in the memory and executable by the processor to perform:
receiving a request for a certificate from a user, the request including a public key having a private key having at least one other corresponding public key;
determining user knowledge of the private key corresponding to the public key to be certified;
incrementing a count of certificates for the user;
generating a message including the incremented count of certificates for the user;
encrypting the generated message; and
issuing and transmitting to the user a certificate having the encrypted message as a serial number.

8. The system of claim 7, wherein a key used to encrypt the generated message is a common key that is the same for all users.

9. The system of claim 7, wherein a key used to encrypt the generated message is different for each user.

10. The system of claim 9, wherein each generated, encrypted message includes a common, public prefix and the certificates for a user can be linked by decrypting messages using the user's key and linking those for which the common, public prefix is found.

11. The system of claim 9, wherein the different key for each user is generated based on a common key.

12. The system of claim 7, wherein the computer program instructions further comprise computer program instructions to perform:
generating a set of serial numbers for a user, each serial number based on an integer from zero up to a count of certificates for the user; and
revoking certificates having the generated serial numbers.

13. A computer program product for issuing certificates in a network of computer systems, the computer program product comprising a computer readable medium and computer program instructions stored on the computer readable medium and executable by a processor to perform:
receiving a request for a certificate from a user, the request including a public key having a private key having at least one other corresponding public key;
determining user knowledge of the private key corresponding to the public key to be certified;
incrementing a count of certificates for the user;
generating a message including the incremented count of certificates for the user;
encrypting the generated message; and
issuing and transmitting to the user a certificate having the encrypted message as a serial number.

14. The computer program product of claim 13, wherein a key used to encrypt the generated message is a common key that is the same for all users.

15. The computer program product of claim 13, wherein a key used to encrypt the generated message is different for each user.

16. The computer program product of claim 15, wherein each generated, encrypted message includes a common, public prefix and the certificates for a user can be linked by decrypting messages using the user's key and linking those for which the common, public prefix is found.

17. The computer program product of claim 15, wherein the different key for each user is generated based on a common key.

18. The computer program product of claim 13, wherein the computer program instructions further comprise computer program instructions to perform:
generating a set of serial numbers for a user, each serial number based on an integer from zero up to a count of certificates for the user; and
revoking certificates having the generated serial numbers.
